(19) United States
(12) Patent Application Publication
(10) Pub. No.: US 2009/0208773 A1
(43) Pub. Date: Aug. 20, 2009

(54) GRADED TRANSITIONS FOR JOINING DISSIMILAR METALS AND METHODS OF FABRICATION THEREFOR

(75) Inventor: John N. DuPont, Whitehall, PA (US)

Correspondence Address: DESIGN IP, P.C., 5100 W. TILGHMAN STREET, SUITE 205, ALLENTOWN, PA, 18104, US

(73) Assignee: LEHIGH UNIVERSITY, Bethlehem, PA (US)

(21) Appl. No.: 12/197,624

(22) Filed: Aug. 25, 2008

Related U.S. Application Data
(60) Provisional application No. 60/957,787, filed on Aug. 24, 2007.

(51) Int. Cl. B32B 5/14; B23K 26/06; B23K 31/02; B05D 7/00

(52) U.S. Cl. 428/610; 219/121.73; 228/101; 427/405

(57) ABSTRACT

A transition joint for joining dissimilar metals with the chemical composition of the joint varied in a controlled manner from end to end. The transition joint has a first end of having a chemical composition similar to that of one of the metals to be joined and a second end having a chemical composition similar to that of the other metal with a gradual composition variation between the first and second ends.

### CROSS REFERENCE TO RELATED APPLICATION(S)

This application claims the benefit of U.S. Provisional Application Ser. No. 60/957,787, filed Aug. 24, 2007, which is incorporated herein by reference as if fully set forth.

### FIELD OF THE INVENTION

The present invention pertains to joining dissimilar metals by the use of graded transition joints.

### BACKGROUND OF THE INVENTION

Many applications exist in the industry that require joining of carbon steels to stainless steels. A typical example can be found in power generation applications. The primary boilers and heat exchangers in coal fired power plants operate at temperatures and environments that permit the use of inexpensive ferritic alloy steels, while the superheater and reheater areas operate at higher temperatures and under more severe corrosion conditions that require the use of austenitic stainless steels. A dissimilar metal weld (DMW) must be made at the alloy steel-to-stainless steel transition region.

These dissimilar metal welds are often prone to premature failure when exposed to elevated service temperatures. Much work has been done to understand the mechanism of dissimilar metal welding failures in such applications.

In the as-welded condition, a steep composition gradient develops near the weld interface of the dissimilar metal weld due to partial mixing between the two materials. The relatively high hardenability associated with this composition gradient, combined with the high cooling rates associated with fusion welding, produce a thin layer of martensite at the weld interface. It is common to observe hardness differences of more than 200 Vickers over distances as short as 250 μm in this transition region. Some applications require that the weld be postweld heat treated (PWHT) before being used in service in order to reduce residual stresses and temper the martensite region, and further microstructural evolution occurs during the post weld heat treating and/or during service. These changes include the formation of a carbon-depleted softened region on the ferritic side of the weld. The low creep resistance in this region, combined with the large stresses that are induced by differences in the coefficient of thermal expansion between the two materials, leads to accelerated creep failures in the softened region.

### SUMMARY OF THE INVENTION

The present invention, in one aspect is a method for welding two structural members where each of said members has a different chemical composition by inserting between structural members a graded transition joint, the graded transition joint having a first end with a chemical composition identical to that of one of the structural members and a second end having a chemical composition identical to that of the other structural member, and a transition section between said first are second ends varying in composition from that of said first end to that of said second end; inserting said graded transition joint between said structural members with each end of said graded transition joint adjacent the like composition of one of the structural members; and welding each end of the graded transition joint to an adjacent structural member.

In another aspect the present invention is a graded transition joint to be inserted between two metals of differing composition comprising a first section having several layers of a first composition having the same chemical composition as that of one of said metals, a second section having several layers having a chemical composition the same as that of said other metal, and an intermediate section having several layers of a composition beginning with a layer having a chemical composition approximating that of said first section and ending with a layer of a composition approximating that of said second section, said intermediate section varying in composition from said beginning layer to said ending layer.

### BRIEF DESCRIPTION OF THE DRAWINGS

FIG. 1 is a schematic representation of a laser engineered net shaping apparatus.

FIG. 2 is a photograph of a device accordingly to the invention.

FIG. 3(a) is a plot of nickel and chromium content against distance from end to end of the device of FIG. 2.

FIG. 3(b) is a plot of carbon, manganese, molybdenum and silicon content against distance from end to end of the device of FIG. 2.

FIG. 4 is a plot of microhardness against distance from end to end of the device of FIG. 2.

FIG. 5a is a photomicrograph of the micro-structure of a portion of the device of FIG. 2.

FIG. 5b is a photomicrograph of a portion of the device of FIG. 2 where a localized hardness peak was observed.

FIG. 6 is an EPMA trace showing varations in chemical composition across several of the cells shown in FIG. 5b.

FIG. 7(a) is an SEM photomicrograph of the microstructure of another portion of the device of FIG. 2.

FIG. 7(b) is an SEM photomicrograph of the microstructure of FIG. 8(a).

FIG. 8(a) is an SEM photomicrograph of the microstructure of the device of FIG. 2 observed in the layer of the joint showing its highest hardness.

FIG. 8(b) is an SEM photomicrograph of the microstructure of FIG. 8a.

FIG. 9(a) is a WRC of composition diagram plotted for the data of FIG. 3a and FIG. 3b.

FIG. 9(b) is a Schaeffler diagram plotted for the data of FIG. 3a and FIG. 3b.

### DETAILED DESCRIPTION OF THE PREFERRED EMBODIMENTS

Stainless steel alloys typically have lower carbon levels than the alloy steels, (e.g.,˜0.03-0.08 wt-% C in stainless steels compared to˜0.10-0.15 wt-% C in alloy steels). This leads to a carbon concentration gradient across the dissimilar metal weld joint. Austenitic stainless steels exhibit a high solubility for carbon and a relatively low diffusivity, while ferritic steels exhibit relatively low solubility and high diffusivity. These differences in carbon solubility and diffusivity, combined with the carbon concentration gradient, strongly promote carbon migration (i.e., from the high-carbon alloy steel side toward the lower-carbon stainless steel side of the joint). Localized variations in carbon concentration have been measured to be as high as 0.7 wt-% to below about 0.01 wt-% over distances on the order of 100 μm.

This severe carbon concentration gradient has several important effects on the microstructure and properties of the dissimilar metal weld. Within the alloy steel side, carbon depletion leads to a significant localized reduction in the creep strength. The increase in carbon content within the transition region affects the microstructure during post weld heat treating in two ways. First, it lowers the Ac1 temperature below that of the post weld heat treating temperature, so that austenite exists in the transition region during post weld heat treating. Second, the carbon combines with Cr to form chromium carbides during post weld heat treating. This not only provides an additional localized increase in hardness, but also removes Cr and C from solution, which has the effect of raising the martensite start temperature. Thus, upon cooling from the post weld heat treating, the region that was austenite with carbides during post weld heat treating transforms into a microstructure consisting of carbides in an as-quenched martensitic matrix. The hardness in this region can be as high as about 500 Vickers. Several hundred microns from this region the carbon denuded ferritic zone can exhibit a reduced hardness on the order of about 130 Vickers. Thus, the original strength gradient that existed in the as-welded condition is exacerbated even further after the post weld heat treating. Similar changes will occur in service upon exposure to the elevated temperature even if a post weld heat treatment is not applied.

Failure of dissimilar metal welds in service has been attributed to the sharp microstructural gradients described previously combined with significant differences in thermal expansion between the two materials. In fact, the coefficient of thermal expansion of austenitic stainless steels are approximately 30% higher than alloy steels over typical operating temperatures of coal-fired power plants. Researchers using finite element modeling have shown that stresses at the weld interface due to this coefficient of thermal expansion mismatch can be as high as 34 ksi for a temperature change of only 170° C., a temperature change that is readily achieved in operating conditions of coal-fired power plants. In view of these factors, the failure of dissimilar metal welds can be summarized as follows. A carbon-depleted region exists on the ferritic side that has significant localized reductions in creep strength. The region directly adjacent to this (typically within 100-300 μm) possesses a martensitic matrix with chromium carbides that exhibits significantly higher strength. As a result, strains induced from external service stresses, which are appreciably amplified from additional stresses due to coefficient of thermal expansion mismatch, are forced onto the soft, low creep strength ferritic side of the joint. This localized strain is relieved by accelerated creep at the service temperature, which results in eventual failure by link up of creep voids within the carbon-denuded zone. This mechanism has been supported by careful characterization of both laboratory and field-induced failures.

Research has been conducted to show that the life of dissimilar metal welds can be extended by the use of nickel-based filler metals and joint designs with wide included angles. The nickel-based filler metals have a coefficient of thermal expansion intermediate to those of the alloy steel and stainless steel, which helps reduce thermal stresses that arise due to coefficient of thermal expansion mismatch. Joint designs with wide included angles help reduce the axial tensile stress that is oriented perpendicular to the creep susceptible weld interface, thus minimizing the creep rate of that area. A survey conducted by the Electric Power Research Institute has shown that the use of wide included angles and nickel-based filler metals can extend the life of dissimilar metal welds by a factor of approximately six. Although these changes help extend the life of dissimilar metal welds, they do not provide a long-term solution to the problem because failures still occur in joints prepared with these modifications.

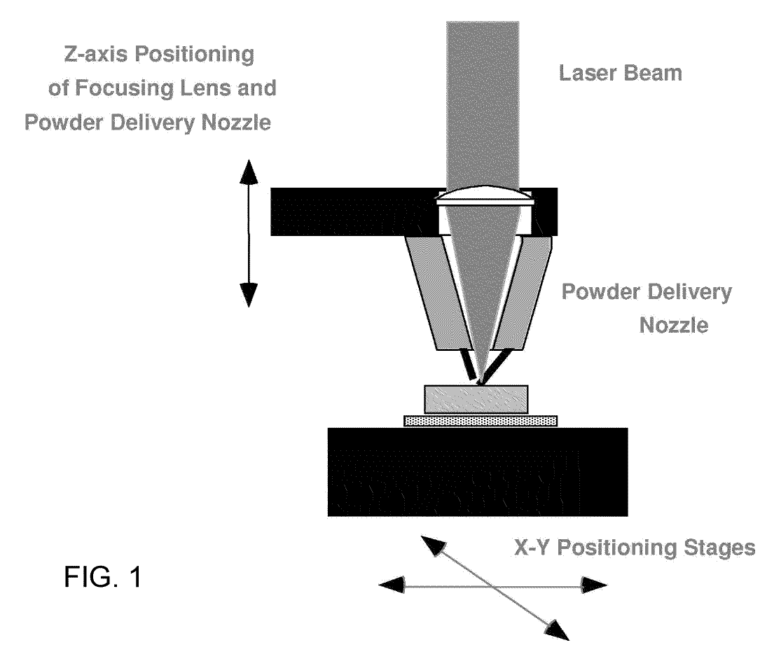

Direct metal deposition refers to a variety of solid free-form fabrication processes that are capable of producing fully dense complex shapes directly from a computer-aided design (CAD) drawing. Laser Engineered Net Shaping is a particular direct metal deposition process that uses a computer-controlled laser system integrated with dual powder feeders. As shown in FIG. 1, the Laser Engagement Net Shaping process utilizes a Nd-YAG laser to produce a melt pool on a substrate attached to an X-Y table. Powder from the dual coaxial powder feeders is injected into the melt pool as the table is moved along a predesigned two dimensional tool path that is “sliced” from the three-dimensional CAD drawing. A fully dense part is produced by depositing successive line builds, which are built into sequential layers. The dual-powder feeders can be controlled independently so that the composition can be changed at various locations within the part for optimized mechanical and/or corrosion performance.

In addition, a melt pool sensor is used to eliminate variations in the pool size that occur due to changes in heat flow associated with variations in part dimensions. The melt pool sensor forms a closed-loop system with the laser power so that the power is automatically varied in real time to maintain a constant pool size.

The relatively high cooling rate associated with laser processing has been shown to produce refined micro structures with improved mechanical properties. Recent research has also shown this process is well suited for fabrication of functionally graded materials. Thus, this process is well suited for fabricating carbon steel-to stainless steel transition joints in which the composition is varied in a controlled manner over relatively large distances. Such a transition joint, in which the sharp changes in composition, microstructure, and concomitant thermal and mechanical properties over short distances are avoided, should help reduce or eliminate the dissimilar metal weld failure problem described above. With this approach, the transition joint could be inserted between a carbon steel and a stainless steel section to permit the deposition of two similar welds at either end of the joint, replacing the single dissimilar weld that is prone to failure.

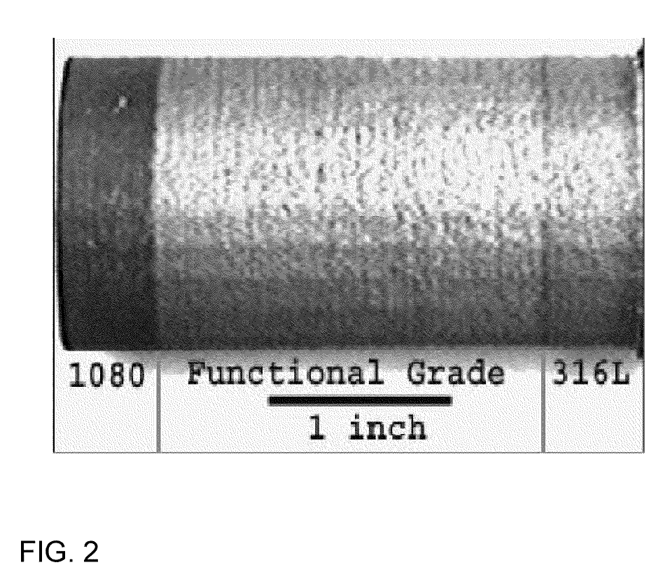

An Optomec Model 750 Laser Engineered Net Shaping direct laser deposition unit was used to build a 76.2-mm-(3-in.-) long transition joint tube with an outer radius of 15.9 mm (0.625 in.) and wall thickness of 6.4 mm (0.25 in.) as shown in FIG. 2. These dimensions were chosen because they represent typical tube dimensions used by the power industry for waterwall panels in fossil-fired boilers.

The transition joint of FIG. 2 was fabricated by first depositing 12.7 mm (0.5 in.) of SAE 316 stainless steel onto an AISI 1020 steel substrate. Next, 50.8 mm (2 in.) of functionally graded material was deposited in which the SAE 316 composition changed gradually to AISI 1080 steel, and concluded with 12.7 mm of AISI 1080 steel. In practice, a much lower carbon content alloy steel would be used for this application. The 1080 steel powder was chosen because, at the time of fabrication, it was the only powder commercially available that had the highly spherical morphology and particle size range required for LENS processing.

The transition joint was fabricated using a travel speed of 16.9 mm/s (40 in./min) and an initial laser power of 350 W.

The laser power was then varied automatically on the fly to keep the melt pool shape constant by use of a closed loop melt pool sensor (MPS). The melt pool sensor operates by continually measuring the size of the pool with an infrared camera and adjusting the laser power to keep the pool size constant.

Each layer in the transition joint was 254 μm (0.01 in.) thick. The initial 12.7 mm length of 316 stainless steel was deposited using 50 layers. The transition region was deposited with 200 layers in which the powder feeders containing each alloy were linearly changed in each layer to vary the composition throughout the graded region. A final 50 layers of 1080 steel was then deposited to complete the transition joint. The entire fabrication required approximately three hours and was conducted in the automatic mode with no need for operator interaction.

Samples were removed from various locations along the transition joint for microstructural analysis. Samples were sectioned and mounted in cold-setting epoxy and prepared to 0.05-μm finish using colloidal silica and standard metallographic techniques. A wide variety of etchants was required to observe the range of microstructures, and the best etchant was chosen for each location. Micro structural characterization was performed along the length of the sample using both light optical microscopy and scanning electron microscopy. Four-millimeter-thick sections were then prepared for wet chemical analysis at 13 locations along the joint.

Local compositional measurements were also acquired using electron probe microanalysis (EPMA) operating at 15-kV accelerating voltage and 65-nA beam current. This accelerating voltage was chosen to minimize the x-ray emission volume while still exciting Kα×rays. Hardness measurements were acquired along the joint using a Knoop indenter and a 1000-g load for 15 s. Five measurements were taken at each location with a 0.5-mm increment between locations, for a total of 760 measurements.

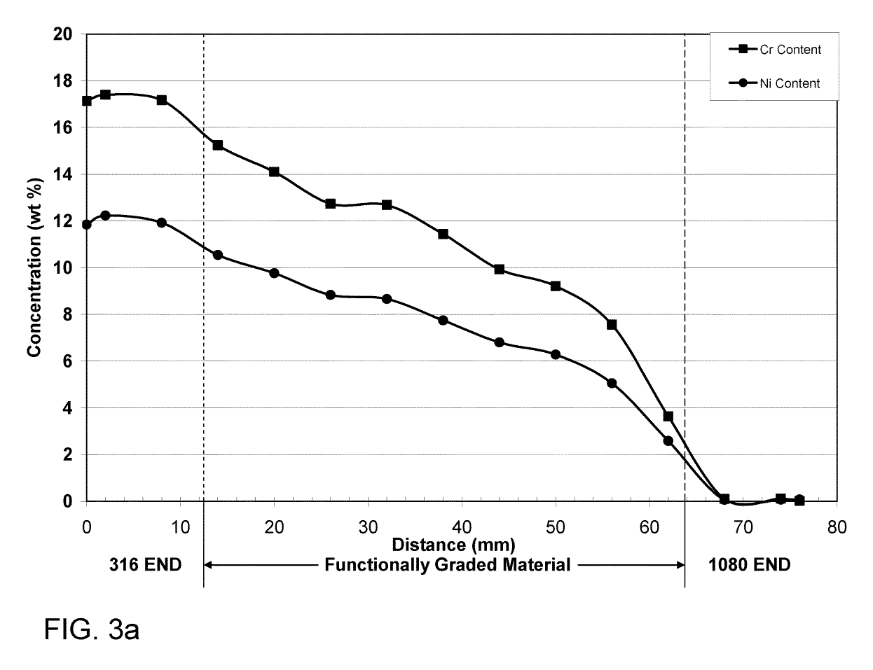

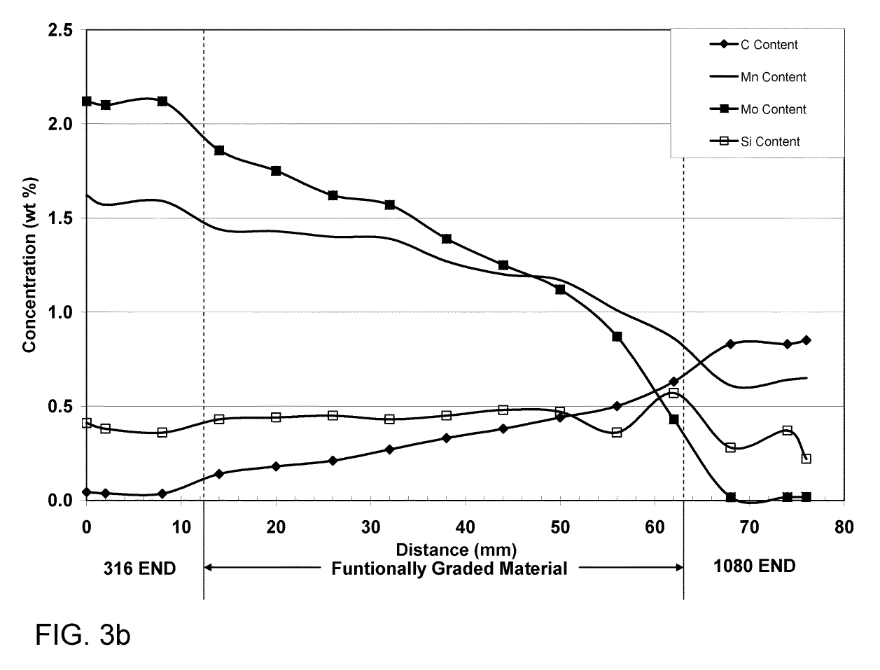

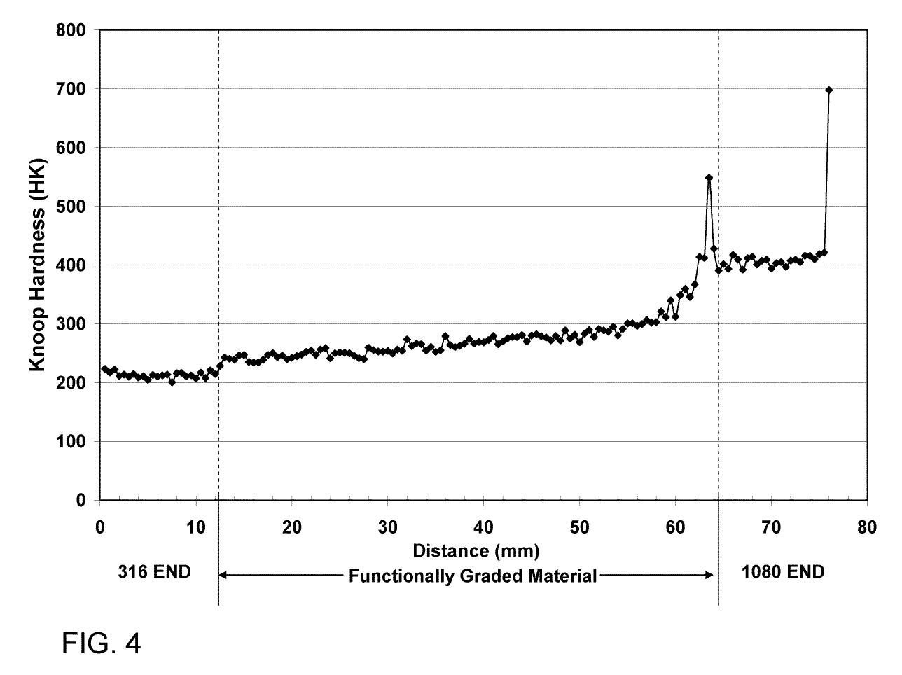

The variation in chemical composition (as determined from wet chemical analysis) along the transition joint is shown in the plots of FIG. 3a and 3b. The first and final 12.7 mm (0.5 in.) ends of the joint have relatively constant compositions. The 50.8 mm (2 in.) length of graded material between the ends varies gradually from 316 stainless steel to 1080 carbon steel. The microhardness results are presented in FIG. 4. The extremities of the 316 and 1080 ends of the transition joint are noted in the figure. The hardness changes in a relatively smooth fashion with two notable exceptions. Local increases in hardness occur at the interface between the functionally graded material and the AISI 1080 end (at˜64 mm) and the final layer of the 1080 steel.

The microstructure that was representative of locations from the 316 end to˜62 mm from the 316 end of the joint was studied. The microstructure in this region exhibited an austenitic matrix with solidification cells that is typical for a stainless steel in which the primary solidification mode is austenite. There may be small amounts of ferrite within the interdendritic region that formed at the end of solidification due to segregation of Cr and Mo, but the microstructure within this region is nearly fully austenitic. The austenite cell spacing in this region is˜3 μm. The relation between cooling rate (ε) and cell spacing (λ) for 310 stainless steel is given by λ=80_{ε}−0.3, where λ is in μm and ε is in C.°/s. This relation should provide a good estimate of the cooling rate in this application since the 316 stainless steel used in this work and 310 stainless steel each exhibit an austenitic solidification mode. Based on the measured cell spacing, the cooling rate is estimated to be approximately 5×10⁴° C./s. Cracks were occasionally observed along the interdendritic and grain boundary regions. The location and morphology of these cracks are consistent with solidification cracks and can be attributed to the primary austenitic solidification mode within this region.

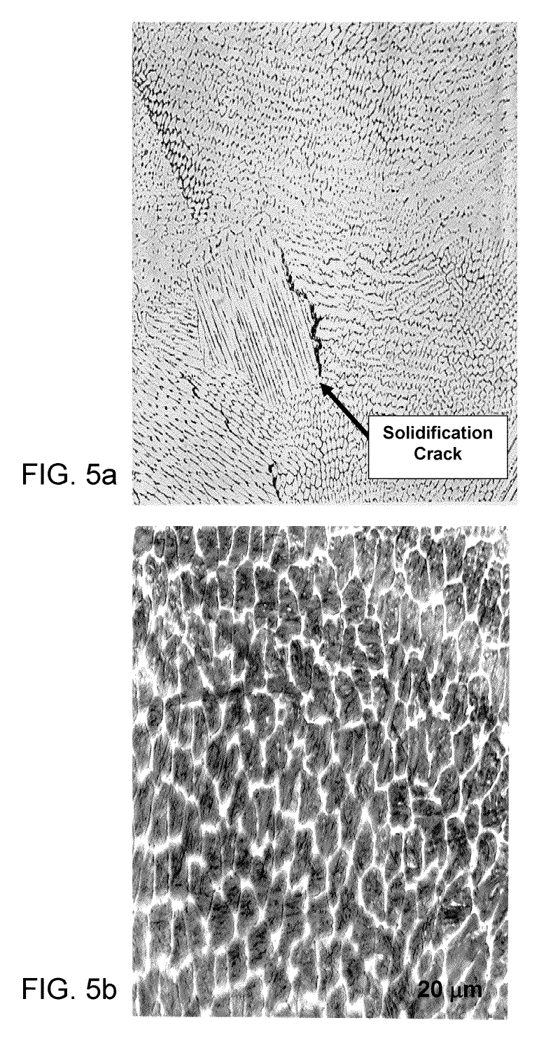

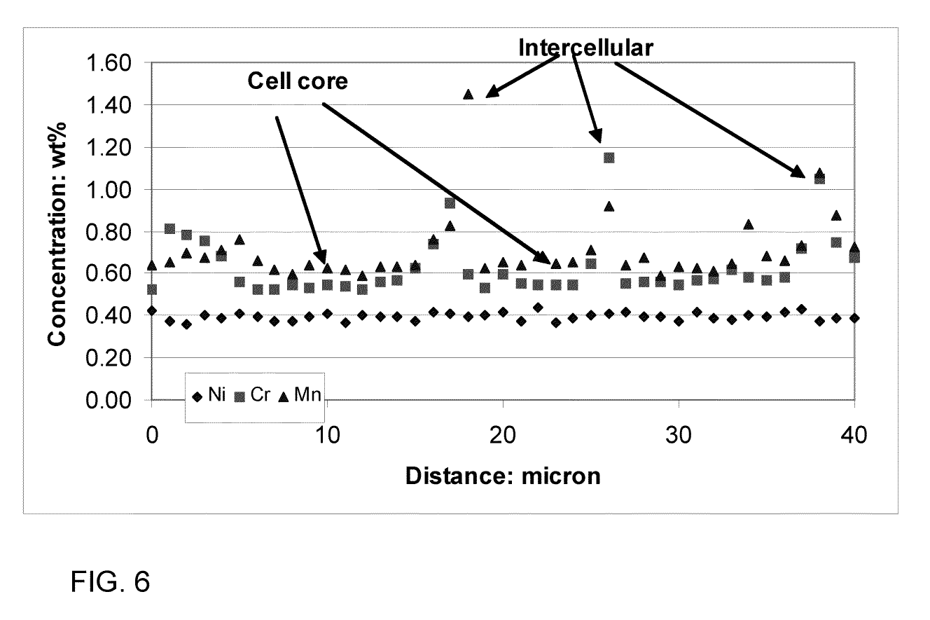

FIG. 5a shows a typical microstructure at location from the 316 and to about 64 mm from the 316 end of the joint. This region shows remnant austenite cells similar to that observed in the previous segment of the joint. However, the regions within the cells have transformed to martensite. Retained austenite exists within the cell boundaries. FIG. 6 depicts an EPMA trace that was acquired across several of the cells shown in FIG. 5b. Note that the distribution of Ni is fairly uniform while Cr and Mn have segregated to the intercellular regions. This distribution pattern is typical for a stainless steel alloy that exhibits an austenitic primary solidification mode. The distribution of Mo could not be measured with the diffracting crystals used in this work, but this element is known to segregate to the interdendritic regions during primary austenite solidification in a manner similar to Mn and Cr.

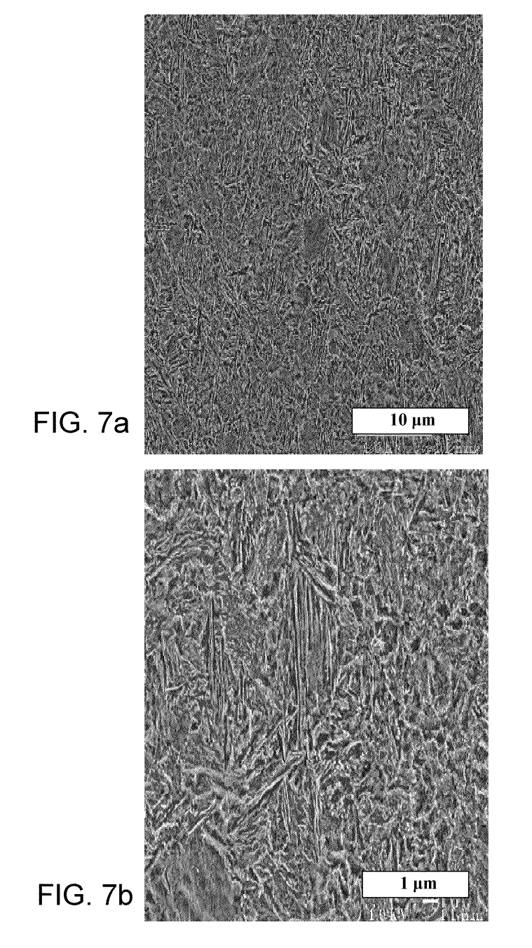

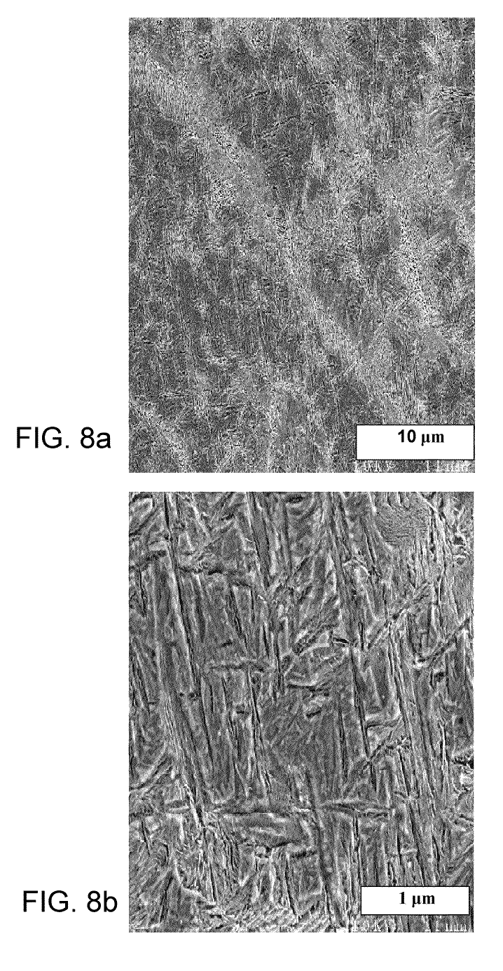

FIG. 7a and FIG. 7b are SEM photomicrographs of the microstructure that was typical from approximately 65 mm to the second to last layer of the joint where the hardness is relatively constant. The microstructure in this region is very fine (due to the relatively high cooling rates associated with the laser processing) and appears to exhibit a combination of bainite/ferrite and tempered martensite. FIG. 8a and FIG. 8b are SEM photomicrographs that show the microstructure observed in the final layer of the joint that was associated with the highest hardness. As with the previous region, the microstructure in this region is extremely fine and difficult to resolve with SEM techniques. The presence of untempered martensite would be consistent for this composition and high cooling rate, and would account for the hardness peak observed in this final layer.

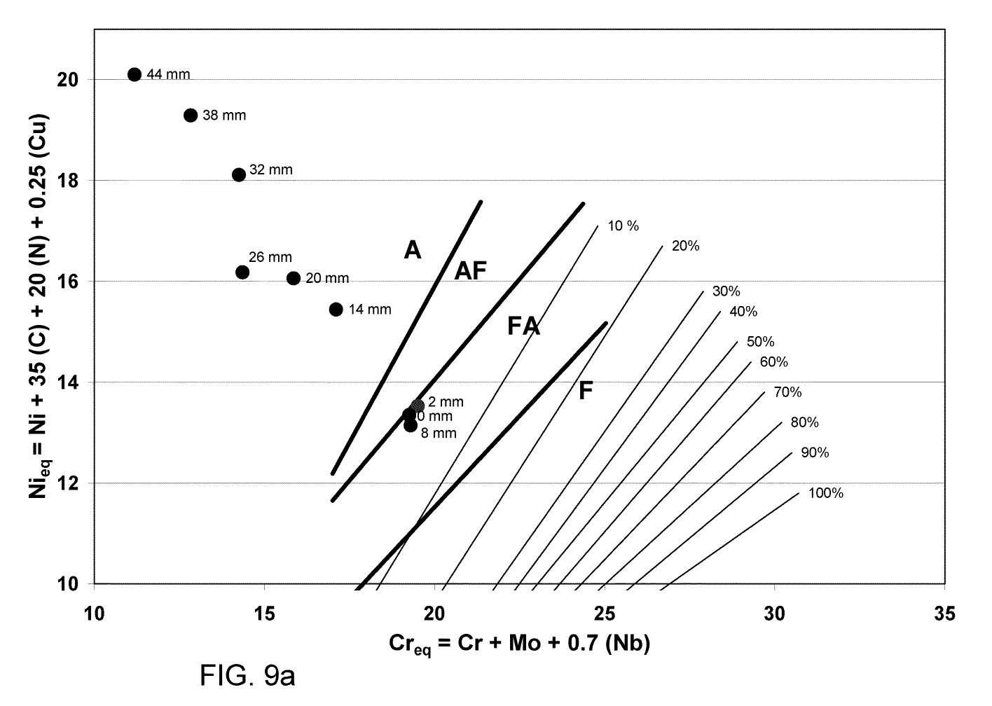

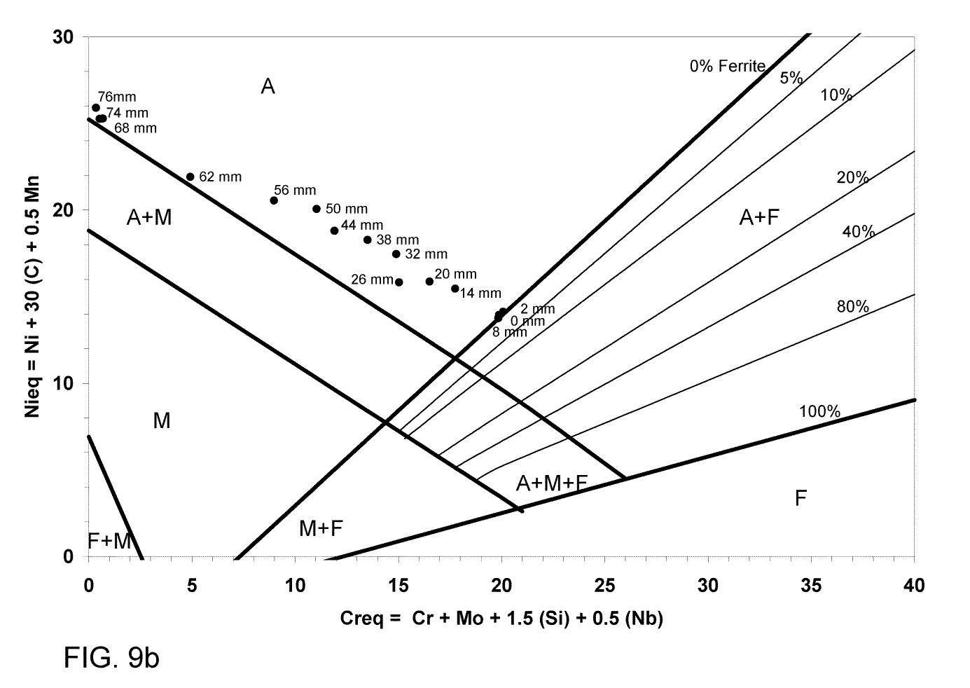

The chemical analysis results shown in FIG. 3a and FIG. 3b demonstrate the feasibility of the Laser Engineered Net Shaping process for fabricating carbon steel to stainless steel transition joints with well-controlled variations in composition. The smooth transition in composition led to a concomitant gradual increase in hardness, except for the two peak hardness locations noted above. Microstructural evolution and the corresponding hardness variations can be understood by plotting the Creq and Nieq values associated with the compositional data from FIG. 3a and FIG. 3b directly on the WRC and Schaeffler stainless steel constitution diagrams as shown in FIG. 9a and FIG. 9b respectively. The locations along the length of the transition joint associated with each Creq and Nieq value are shown within the plots for reference. The Schaeffler diagram is useful because it contains a martensite line that is pertinent to this work, while the WRC diagram is useful because it aids in identifying the expected primary solidification mode. (Creq and Nieq values plotted on the WRC diagram are limited to locations from 0 to 44 mm along the transition joint due to the more limited composition space associated with the WRC diagram.)

The composition of the 316 powder used for fabrication of the device FIG. 2 exhibits Creq and Nieq values that place it very close to the boundary separating the AF and FA solidification modes on the WRC diagram. The microstructure observed in this region (FIG. 5) clearly solidified in the A or AF mode. Note that the Schaeffler, Creq and Nieq values for the 316 also place it very close to the boundary at which a fully austenitic microstructure would be expected. Thus, the observed primary austenite solidification mode can be attributed to the slight inaccuracies of the diagrams in regions close to the boundaries or a shift in primary solidification mode induced by the relatively high cooling rate conditions. In either case, the austenitic microstructure observed at the 316 stainless steel end is consistent for the composition and cooling rate conditions in this region.

Successive additions of 1080 steel into the 316 stainless steel within the graded region has the effect of decreasing the Creq and increasing the Nieq. The decreased Creq is expected when a stainless steel is diluted with carbon steel, while the increase in Nieq can be attributed to the high carbon content of the 1080 powder used in this particular application. (As mentioned previously, the 1080 powder was used here because, at the time of fabrication, it was the only powder commercially available that had the spherical morphology and particle size range required for Laser Engineered Net Shaping. Lower carbon alloy steel powders would likely be used in actual practice.) This variation in composition causes the Nieq and Creq values to move from that of the 316 into the fully austenitic phase field in both the WRC and Schaeffler diagrams, and this accounts for the fully austenitic microstructure observed from the 316 end to approximately 62 mm from the 316 end of the joint.

The first hardness spike observed at approximately 64 mm can be attributed to the formation of martensite in this region. The compositional data plotted on the Schaeffler diagram in FIG. 9b show that the Creq and Nieq values are approaching the austenite +martensite phase field of the diagram as the 1080 end of the transition joint is reached. Based on the Creq and Nieq values derived from the nominal composition values plotted in FIG. 9b, and assuming the Schaeffler A+M phase boundary line is highly accurate for this compositional range, martensite would not be expected to form because the Creq and Nieq values never enter into the A+M phase field.

This apparent discrepancy can be understood by considering the localized variation in composition that exists across the austenite cells due to microsegregation, as shown previously. Note that the alloy content is lowest in the cell cores and highest in the cell boundaries. As a result, the Creq and Nieq values are lower in the cell interior regions compared to those in the cell boundaries. This has the effect of shifting the Creq and Nieq values of the cores down and to the left into the A+M phase field, and this accounts for the presence of martensite in the cell core regions. By comparison, the relatively high alloy content in the cell boundaries shifts the Creq and Nieq values up and to the right into the single-phase austenite phase field, which has the effect of stabilizing austenite in the cell boundaries.

This effect can be viewed in a more basic way by considering the influence of alloying additions on the martensite start temperature (Ms). It is well known that alloying elements such as Mn, Ni, Cr, and Mo reduce the Ms temperature. Carbon has an even stronger effect on lowering the Ms temperature than the substitutional alloying elements. However, it is well known that C diffusion in austenite is high enough to avoid the microsegregation exhibited by the substitutional alloying elements. Thus, the C concentration across the cells is expected to be uniform and would not cause any variation in the Ms temperature across the cells. (Carbon cannot be measured accurately using EPMA techniques.) Microsegregation of the substitutional alloying elements effectively leads to a variation in Ms temperature across the cells. The Ms temperature is above room temperature in the cell core regions, leading to martensite formation. The relatively high alloy content of the cell boundaries lowers the Ms temperature below room temperature, which has the effect of stabilizing the austenite at this location. Finally, the increased hardenability caused by the slightly elevated alloy content in this region (relative to 1080 steel), combined with the high cooling rate associated with laser processing, provides conditions in which the Ms temperature is reached in the core regions before any diffusional-type transformations can occur. These factors account for the microstructure shown in FIG. 5 and localized hardness peak shown in FIG. 3.

The final region of the transition joint consists of laser-deposited “pure” 1080 steel. The layers that experienced post deposition thermal excursions from subsequent passes exhibited a constant hardness of about 400 Knoop, while the very last pass exhibited a hardness of 700 Knoop. The microstructure in this region is very fine (due to the relatively high cooling rates associated with the laser processing). Reference to the continuous cooling transformation diagram for 1080 steel indicates that an as-quenched hardness of 700 Vickers is typical for a martensitic/bainitic microstructure that would form under these cooling rates. Thus, the high hardness associated with the final pass can be attributed to the formation of as-quenched martensite, while the lower hardness values exhibited by the remaining section of the 1080 region can be attributed to tempering from the thermal treatment of subsequent layers. The hardness spike associated with the last layer would not pose a problem since it can be easily removed by machining prior to use. More importantly, actual use of the transition joint would involve the use of an alloy steel with lower carbon where this high hardness region may not form to begin with.

The graded transition joint fabricated and described herein consisted of a 1080 steel transitioned to a 316 stainless steel. This couple was used for demonstration purposes. In actual applications, a Cr—Mo type alloy steel would be joined to a conventional type stainless steels (e.g., 304 or 316 type) or a stabilized stainless steel (e.g., 321 or 347 type). In addition, research conducted to date has shown that, when these types of alloys are welded directly to each other, it is advantageous to join them with a nickel base filler metal. The nickel base filler metal has a coefficient of thermal expansion that is intermediate to the Cr—Mo steel and stainless steel. Thus, use of a nickel base filler metal helps minimize the sharp change in coefficient thermal expansion that is partially responsible for dissimilar weld failures.

The methods and apparatus according to the invention will minimize or eliminate dissimilar metal weld failures.

While the principles of the invention have been described above in connection with preferred embodiments, it is to be clearly understood that this description is made only by way of example and not as a limitation of the scope of the invention which is sought to be protected by Letters Patent of The United States as set forth in the appended claims.

1. A method for joining two structural members where each of said members has a different chemical composition by inserting between said structural members a graded transition joint said graded transition joint having a first end with a chemical composition identical to that of one of said structural member and a second end having a chemical composition identical to that of said other structural member, and a transition section between said first and second ends varying in composition from that of said first end to that of said second end;
inserting said graded transition joint between said structural members with each end of said graded transition joint adjacent the like composition of one of the structural members; and
welding each end of said graded transition joint to an adjacent structural member.

2. A graded transition joint to be inserted between two metals of differing composition comprising a first section having several layers of a first composition having the same chemical composition as that of one of said metals, a second section having several layers having a chemical composition the same as that of said other metal, and an intermediate section having several layers of a composition beginning with a layer having a chemical composition approximating that of said first section and ending with a layer of a composition approximating that of said second section, said intermediate section varying in composition from said beginning layer to said ending layer.

3. A graded transition joint according to claim 2 wherein one of said metals is stainless steel and said other metal is carbon steel.

4. A graded transition joint according to claim 2 wherein one of said metals is stainless steel and said other metal is an alloy steel.

5. A method for fabricating a graded transitional number to be interposed between two members of differing chemical composition comprising the steps of;
disposing at least one layer having a composition identical to that of one said members, depositing a plurality of successive layers varying in chemical composition from that of said first layer to a final layer having a chemical composition identical to said other of said members.

6. A method according to claim 5 including the steps of depositing said layers using a laser engineered net shaping process.
